(19) United States
(12) Patent Application Publication
(10) Pub. No.: US 2010/0197183 A1
(43) Pub. Date: Aug. 5, 2010

(54) INDUSTRIAL ABSORBENT FROM COTTON REGIN

(76) Inventors: David C. Drapela, Brown Deer, WI (US); John Sellars, Wauwatosa, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/696,144

(22) Filed: Jan. 29, 2010

Related U.S. Application Data
(60) Provisional application No. 61/148,655, filed on Jan. 30, 2009.

(51) Int. Cl. D04H 1/12; D04H 1/02; D04H 1/54; D04H 1/20; B32B 5/26

(52) U.S. Cl. 442/35; 442/361; 442/57; 264/115; 264/112

(57) ABSTRACT

A product and process of manufacturing a non-woven web from cotton regin for use as an industrial hydrophobic absorbent, a filter or insulator. The method of processing the cotton regin creates a low-density and, thus, a high-absorbency web. The finished web has a bulk-to-weight ratio of about 25 to 40 mils/osy. The method includes processing cotton regin to a suitable range of fiber and particle sizes, mixing the cotton regin with a thermoplastic bonding agent, and depositing the material onto a steadily advancing belt to produce a relatively low density, loosely formed web. Subsequent processing of the web in an oven softens or melts the bonding agent, thereby adheres it to other web material to give the web its required strength and integrity. One or more continuous, air-permeable layers of scrim or netting may be incorporated on or within the web to provide additional strength or particular surface characteristics.

### BACKGROUND

Industrial absorbents, including hydrophobic industrial absorbents, are used in a variety of circumstances, particularly in manufacturing facilities to absorb oil that may be dispensed, emitted, or leaked from various machines and manufacturing lines.

### SUMMARY

Although current industrial hydrophobic absorbents are functional, absorbents with improved characteristics such as, for example, increased absorbency and lower cost, would be beneficial. An absorbent produced from relatively inexpensive byproducts or waste material offers certain advantages. For example, “cotton regin” is a byproduct from cotton production. Cotton regin is relatively inexpensive and offers environmental benefits because it is a source of renewable, natural fibers. Most currently available industrial hydrophobic absorbents are made largely from polypropylene, a more expensive and non-renewable resource derived from petroleum.

Cotton regin is, more precisely, a byproduct of the cotton ginning process, in which cotton fibers are separated from seedpods. During the process of cotton ginning, as much as 30% by weight of the harvested seed cotton is removed as waste, including dirt, sticks, leaves, seeds, and cotton motes (fibrous material from which most of the high-grade long cotton fibers have been removed). The cotton motes are offered for sale as a source of low-grade cotton due to the short length and off-color appearance of the remaining fibers. Further cleaning and ginning of the motes produces a short-fiber grade of cotton referred to as cotton regin, or cotton reginned motes. The process of removing the short fiber from the motes or re-ginning the motes results in a further byproduct referred to as cotton pills or cotton reginned pills, typically comprising shorter fibers and a higher debris content than the grade of cotton referred to as cotton reginned motes. All forms of fiber removed from the cotton motes produced as byproducts of the cotton ginning process are hereinafter referred to as “cotton regin”. The byproducts of the cotton ginning process are different than the product of that process, which is cotton. Cotton regin is naturally hydrophobic due to the presence of cotton seed oil.

Due to its short and inconsistent fiber lengths and its relatively high debris content, cotton regin is unsuitable for many currently available non-woven web forming methods, such as cards or air-laid systems in which the web material must pass through a screen to remove debris and unopened nits of fiber. However, in certain aspects, the present invention provides a method where substantially all forms of cotton regin may be processed and formed into an industrial hydrophobic web, which may have higher oil absorbency than similar absorbents made from polypropylene.

In one embodiment of the invention, a dry-laid web is provided that includes cotton regin combined with individuated bicomponent fibers acting as the thermal bonding agent. The constituent fibers and particles of the web vary in size over a wide range, from that of fines (short, individuated fibers) to loosely entangled clumps of fibers up to 1″ across or slightly larger. The finished material is a thermally bonded web of cotton regin and bicomponent fibers, which may be produced with an amount of compression sufficient to ensure web integrity, without causing an undesirable increase in density. Typically, the web's absorbency varies inversely with its physical density. The amount of bicomponent fiber combined with the cotton regin (typically 6% to 12% of total web weight, or, in another embodiment, 8% to 10% of total web weight) is sufficient to obtain the required web strength but is also limited to allow the web to rebound after thermal bonding or compression processes in order to prevent or inhibit excessive loss of bulk.

In another embodiment, a hydrophobic absorbent includes a thermally bonded outer scrim on at least one surface. The finished product also includes a thermally bonded web of cotton regin mixed with bicomponent fibers, produced so as to have a lower density (higher bulk) than many currently available competing products. The scrim is made from at least one thermoplastic material, which, during the web bonding process, becomes adhered to at least some of the cotton regin and/or some of the bicomponent fibers along one surface of the web. The result is a web with potentially greater tensile strength than one without an outer scrim (depending upon the amount of bicomponent fiber in the web) and one with some degree of scuff resistance on the scrim side.

In still another embodiment, a hydrophobic absorbent includes a thermoplastic outer scrim on both outer surfaces of a thermally bonded web of cotton regin combined with bicomponent fibers. The result is a web with some degree of scuff resistance on both surfaces and greater tensile strength than a similar web with one or no outer scrim.

In still another embodiment, a hydrophobic absorbent includes a layer of netting material either embedded within, or attached to one surface of the web of cotton regin combined with bicomponent fibers. The thermally bonded web of cotton regin mixed with bicomponent fibers is produced so as to allow some amount of web material to pass through the open netting during web formation. The netting material thereby becomes embedded to some degree within the web material during the thermal bonding process. The netting material may also consist of at least one thermoplastic material which bonds to the web material during thermal bonding. The result is a web with greater tensile strength than a similar web without netting or a scrim, but with little to no significant changes to surface characteristics.

In another embodiment, a method of manufacturing a hydrophobic absorbent web from cotton regin is provided. The cotton regin is opened and sized (reduced to a range of fiber and clump sizes suitable for web formation) and combined with bicomponent fiber. The processed web material is then transported pneumatically to a chute or reserve section and then metered into a forming head from which it is deposited onto a moving, air-permeable forming wire (or belt). Depositing the web material to form a web includes sprinkling the material over a defined area of the forming belt so as to gradually form a web under the influences of gravity and of an air stream flowing down through the web into a suction box positioned beneath the forming belt. The web is then heated in an oven to cause an outer layer of the bicomponent fiber to melt or soften. The melted or softened outer layer of the bicomponent fiber contacts other fibers and, when re-hardened or cooled, creates bonds.

If the web exiting the oven is inadequately bonded, as indicated by, for example, unacceptably low tensile strength, a tendency to not remain intact when subjected to conditions typical of those for its intended use, or the like, the integrity of the web can be improved by, for example, using a higher proportion of bicomponent fiber, increasing the amount of compression on the web either during or after the heating process, or both. Web compression, achieved by passing the web through a compression nip formed between a belt and a roller or between two rollers, can also be employed to increase web density.

If the process includes applying an outer thermoplastic scrim to one or both surfaces of the web, the heating process causes at least a portion of the thermoplastic scrim to bond with the web. If a scrim is applied to one surface, the scrim is typically provided on the bottom surface of the web. The scrim is positioned below the forming head such that the web is formed on top of the scrim. If a second scrim is applied to the web, the scrim is applied to the top of the formed web before entering the oven or heating section.

If a netting material is included in the web, the netting is positioned below the forming head and for some distance above the forming wire such that a portion of the web material falls through the netting during web formation. The netting is then lowered onto the web material that has fallen through the netting, and the netting is thereby embedded to some extent within the web.

Independent aspects of the invention will become apparent by consideration of the detailed description, claims and accompanying drawings.

### BRIEF DESCRIPTION OF THE DRAWINGS

FIG. 1 is a flow chart illustrating a process of manufacturing a product, such as an absorbent including a hydrophobic absorbent web from cotton regin.

FIG. 2 is a schematic view of the process of FIG. 1.

FIG. 3 is a bottom view of a product including a web and a netting and manufactured by the process of FIG. 1.

FIG. 4 is a cross-sectional view of the pad taken along line 4-4 of FIG. 3.

FIG. 5 is a bottom perspective view of a second product including a web and a scrim and manufactured by the process of FIG. 1.

FIG. 6 is a cross-sectional view of the second pad taken along line 6-6 of FIG. 5.

FIG. 7 is a bottom perspective view of a third product including a web and manufactured by the process of FIG. 1.

FIG. 8 is a cross-sectional view of the third pad taken along line 8-8 of FIG. 7.

FIG. 9 is a schematic view of a modified process of making any of the illustrated pads.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Although references may be made below to directions, such as upper, lower, downward, upward, rearward, bottom, front, rear, etc., in describing the drawings, these references are made relative to the drawings (as normally viewed) for convenience. Unless specifically indicated, these directions are not intended to limit the present invention in any form. In addition, terms such as “first” and “second” are used herein for purposes of description and are not, unless specifically stated, intended to indicate or imply relative importance or significance.

### DETAILED DESCRIPTION

In one embodiment, a product, such as an industrial absorbent, includes a hydrophobic absorbent web formed or made from cotton regin combined with bicomponent fibers. In other independent embodiments, one or more scrim or netting layers are incorporated on or within the produced web. In some embodiments, the product is, for example, a filter or an insulator.

In one such embodiment, the scrim is an air-permeable sheet made of bicomponent fibers consisting of an inner core of polypropylene and a sheath or outer layer of polyethylene. The individuated bicomponent fibers within the web are commonly of the same or similar composition (i.e., have an inner core or polypropylene and an outer sheath of polyethylene). The outer sheath of polyethylene has a lower melting point than the core of polypropylene. An outer scrim layer is heated in an oven while in contact with a surface of the web such that melted or softened polyethylene in the bicomponent fibers of the scrim comes in contact with fibers on a surface of the web. As the web and outer scrim layer or layers cool, the polyethylene in the scrim, as well as in the individual bicomponent fibers within the web, re-hardens to form bonding points with at least some adjacent fibers.

In another such embodiment, a netting configured with approximately 2 to 5 lines (or threads) per inch is made of plastic which does not significantly soften or melt in the heating section. The netting is retained above a conveyor surface so that some of the web material (the cotton regin and bicomponent fibers) falls through the netting. This enables the netting to be affixed to the web by being (to some degree) embedded within the web material. The web, with embedded netting, is heated in an oven such that melted or softened polyethylene in the bicomponent fibers is in contact with other fibers of the web and/or with the netting. As the web cools, the polyethylene in the individual bicomponent fibers re-hardens to form bonding points with at least some adjacent fibers and/or with the netting.

The method of web formation accommodates a wide range of cotton regin fiber lengths and particle sizes, from fines to considerably larger clumps of loosely entangled fibers, and provides the opportunity to produce a finished web with a relatively high bulk-to-weight ratio of between 25 and 40 mils/osy. A high bulk (low density) helps to achieve a relatively high absorbency of between 20 and 30 times web weight, depending in part on the properties of the absorbed oil.

A high bulk finished product is achieved in part by a method that does not require mechanical compression of the unbonded web material in order to form a web. The forming head sprinkles web material onto a steadily advancing forming belt where it forms a web under no more compression force than that resulting from gravity and the downward flow of air through both the web and the forming belt. The air flow is generated by a suction fan, the inlet of which is connected to a suction box positioned beneath the forming belt.

If needed to encourage the formation of bonds between cotton regin and bicomponent fibers, some amount of compression may be applied to the web after being heated in the oven. The compression is typically accomplished by means of an adjustable gap between two rollers. The amount of compression applied varies inversely with the size of the gap, which is adjusted on the basis of the desired strength and density of the web.

The strength and density of the web also tend to vary in relation to the amount of individuated bicomponent fibers in the web. In one embodiment, the web includes about 8% to 12% of staple bicomponent fibers by total web weight, the bicomponent fibers being crimped and approximately ¼″ long. In general, the higher the proportion of bicomponent fiber, the stronger and denser the finished product. The remainder of the web consists of cotton regin and, in some embodiments, includes one or more layers of scrim or netting.

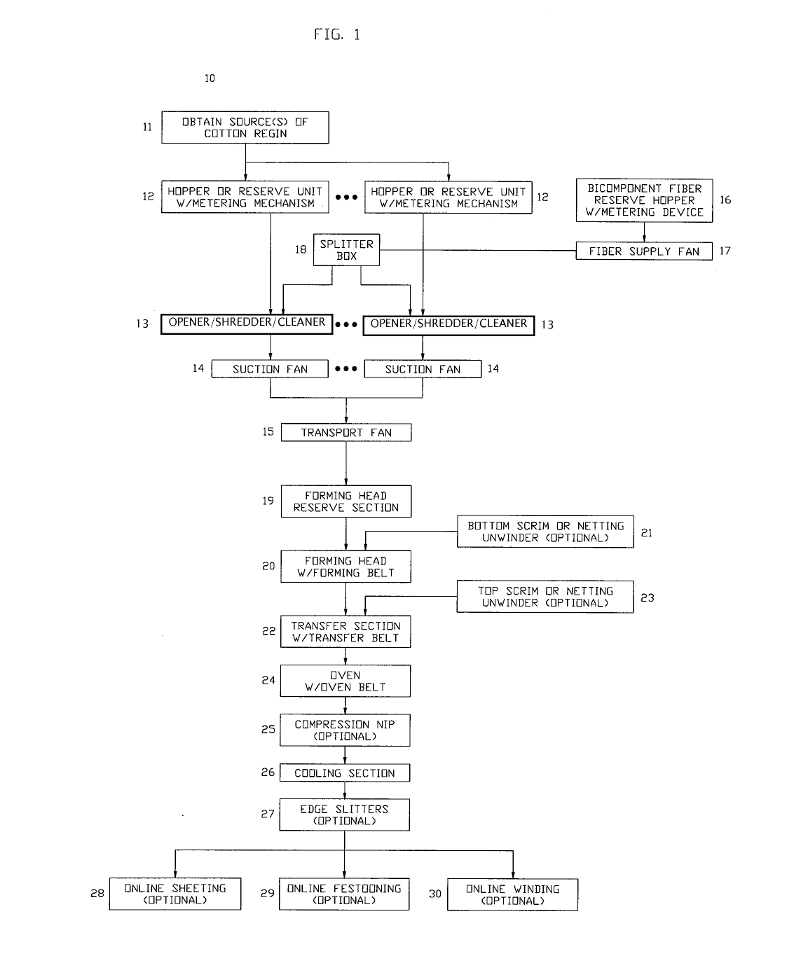

FIG. 1 illustrates a process 10 for manufacturing a product, such as, for example, an absorbent, filter or insulator, including a dry-laid, thermally bonded web of cotton regin combined with bicomponent fiber. The process 10 begins at step or block 11 in which cotton regin is obtained from one or more source(s) and then loaded into one or more reserve hoppers (blocks 12). The cotton regin is then metered at a controlled rate from the one or more reserve hoppers (blocks 12) into one or more devices used to open, shred and clean the cotton fiber (blocks 13). The devices (block 13) are hereinafter referred to as shredders, and are capable of at least one of opening the cotton fiber, shredding the cotton fiber and cleaning the cotton fiber.

Bicomponent fiber is stored in and metered at a controlled rate from a reserve hopper (block 16) into a fiber supply fan (block 17), which introduces the bicomponent fiber into the inlet of one or more shredders (blocks 13). The bicomponent fiber is mixed with the cotton regin in the shredder and the cotton fibers and clumps are reduced in length and overall size. A single bicomponent supply fan (block 17) may be used for multiple shredders (blocks 13) by means of an intermediate splitter box (block 18) by which the stream of bicomponent fiber is divided roughly equally for each of the individual branches supplying said fiber to the shredders. The mixed combination of processed cotton regin and bicomponent fiber exits the shredders (blocks 13) with pneumatic assistance provided by respective suction fans (blocks 14).

In some embodiments, the method includes multiple reserve hoppers (blocks 12), and each hopper feeds cotton regin at a metered rate into a separate shredder (blocks 13). Each shredder is coupled to a separate suction fan (blocks 14) by which the mixed and processed web material is pneumatically conveyed to a single transport fan (block 15). The use of multiple equipment lineups, as described in this embodiment, offers a number of practical and operational advantages over a single lineup (each lineup including one hopper (block 12), one shredder (block 13) and one suction fan (block 14)). For example, the process is less dependent on the performance or uptime of a single piece of equipment, and the use of multiple hoppers (blocks 12) offers the opportunity to blend different grades of cotton regin at controlled rates. Also, the use of a single lineup, as described above, often requires much larger equipment to handle the total required throughput of processed web material and often requires a considerably more powerful and aggressive shredder (blocks 13) to perform the total amount of work required to sufficiently reduce the cotton regin particles and clumps to a range of sizes suitable for web formation.

The transport fan (block 15) conveys the processed web material to the forming head chute or reserve section (block 19). The reserve section (block 19), situated on top of the forming head (block 20), meters web material at a controlled rate into the forming head.

The forming head (block 20) disperses and deposits the web material over a defined area of the advancing forming belt (included in block 20) to gradually form the pre-bonded web. A forming head suitable for use in making the web is described in U.S. Pat. No. 7,627,933, the contents of which are hereby incorporated by reference.

If desired for inclusion in the end product (e.g., an absorbent or insulator), a bottom layer of scrim is unwound from a first unwinder (block 21) and carried under the forming head on top of the forming belt. The web is then formed on top of the bottom scrim.

In addition or as an alternative to a bottom scrim, netting may be included in the end product. To so form the end product, a layer of netting is unwound from a first unwinder (block 21) and carried under the forming head and, for some distance while under the forming head, above the forming belt. Some amount of web material (the cotton regin and bicomponent fibers) falls through the netting, causing the netting to become at least partially embedded within the web material.

A top scrim may be included in the end product by unwinding the scrim from a second unwinder (block 23) and carrying it on top of the web either while the web is still on the forming belt after the forming head or while the web transitions from the forming belt (included in block 20) to a transfer belt (included in block 22), which leads to another station such as an oven.

The bottom scrim, the netting, and the top scrim can be utilized in combination or individually, to enhance the strength and/or durability of the web. The netting could also be provided adjacent a top surface or be fully embedded within the web.

In some embodiments, scrim and netting are omitted completely. In a first alternative, cotton regin and bicomponent fiber are formed into a web, albeit one that is weaker than a web with netting or a scrim.

In a second alternative, loose material (i.e., cotton regin or cotton regin mixed with bicomponent fiber is collected from the forming head without being deposited on a forming wire or belt. Such loose material can be sprinkled on a spill and then later swept or vacuumed up. The loose material may also be placed or stuffed in a container such as a cotton or acrylic sock. The sock can be placed along the perimeter of an area to help contain a spill.

The transfer section (block 22) transfers the web from the forming belt to the oven belt (included in block 24). The web is conveyed from the transfer section (block 22) to the oven (block 24), where it is heated sufficiently to cause the melting or softening of the polyethylene in the individuated bicomponent fibers and, optionally, in the scrim layer(s). Molten or softened polyethylene in contact with other fibers in the web creates bonds when the polyethylene is cooled and hardened. As the web exits the oven, it may be taken through an optional compression nip (block 25) in order to squeeze the web for the purpose of encouraging thermal bonds and possibly to intentionally reduce the bulk of the finished product. The web is then cooled in a cooling section (block 26) in order to set the thermal bonds.

Different methods and devices for online converting may be employed to produce the desired form of a finished product. FIG. 1 illustrates a number of possible alternatives, including an edge slitter (block 27) for trimming the edges of the web to a fixed width. As illustrated, after the edge slitter (block 27), converting alternatives may be provided for sheeting (block 28), festooning (block 29), winding (block 30), etc., the finished web. These optional steps can be utilized in combination with each other or can be omitted completely.

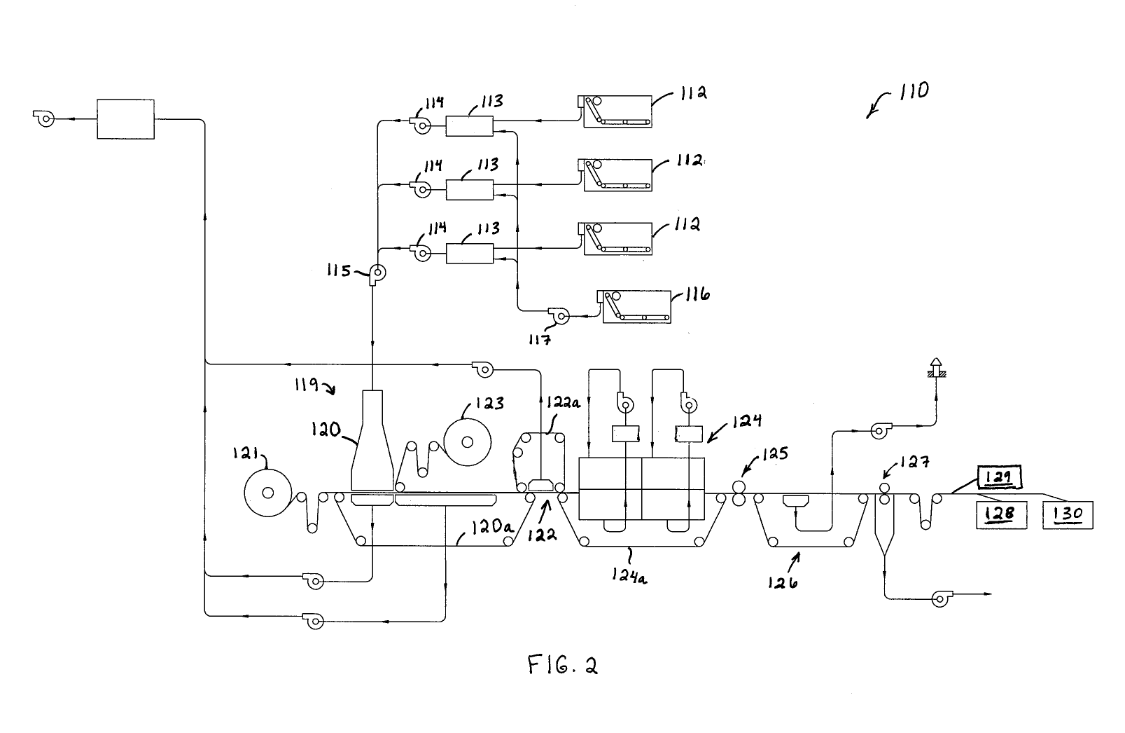

FIG. 2 is a schematic view of the manufacturing line 110 for the process 10 shown in FIG. 1 and described above. In FIG. 2, structure of the manufacturing line 110 corresponding to a step or block in the flow chart of FIG. 1 has the same reference number in the “100” series.

In the manufacturing line 110, cotton regin is obtained from one or more source(s) and then loaded into one or more reserve hoppers 112. The cotton regin is then metered at a controlled rate from the one or more reserve hoppers 112 into one or more devices 113 used to open, shred and clean the cotton fiber. In the illustrated embodiment, three reserve hoppers 112 and three associated devices 113 are utilized, but, it should be understood that other numbers of reserve hoppers 112 and respective devices 113 are possible.

Bicomponent fiber is stored in and metered at a controlled rate from a reserve hopper 116 into a fiber supply fan 117, which introduces the bicomponent fiber into the inlet of one or more shredders 113. The bicomponent fiber is therein mixed with the cotton regin as the cotton fibers and clumps are reduced in length and overall size. A single bicomponent supply fan 117 may be used for multiple shredders 113 by means of an intermediate splitter box (block 18, see FIG. 1) by which the stream of bicomponent fiber is divided roughly equally for each of the individual branches supplying the bicomponent fiber to the shredders 113. The mixed combination of processed cotton regin and bicomponent fiber exits the shredders 113 with pneumatic assistance provided by respective suction fans 114.

In the illustrated embodiment, the manufacturing line 110 includes multiple reserve hoppers 112, and each hopper 112 feeds cotton regin at a metered rate into a separate associated shredder 113. Each shredder 113 is coupled to a separate associated suction fan 114 by which the mixed and processed web material is pneumatically conveyed to a single transport fan 115.

The transport fan 115 conveys the processed web material to the forming head chute or reserve section 119. The reserve section 119, situated on top of the forming head 120, meters web material at a controlled rate into the forming head 120. The forming head 120 disperses and deposits the web material over a defined area of the advancing forming belt 120a to gradually form the pre-bonded web. A forming head 120 suitable for use in making the web is described in U.S. Pat. No. 7,627,933, as discussed above.

As noted above, the web can be formed with a netting, a bottom scrim, a top scrim, or a combination of these elements. If included in the end product, a bottom layer of scrim 314 is unwound from a first unwinder 121 and carried under the forming head on top of the forming belt 120a. The web is then formed on top of the bottom scrim 314.

Netting may be placed in the end product by unwinding it from the first unwinder 121. The netting is carried under the forming head 120 and, for some distance while under the forming head 120, above the forming belt 120a. Some amount of web material thereby falls through the netting 304, causing the netting 304 to become embedded (at least partially) within the web material.

To include a top scrim 314, the scrim is unwound from a second unwinder 123 and carried on top of the web either while the web is still on the forming belt 120a after the forming head 120 or while the web transitions from the forming belt 120a to the transfer belt 122a.

The transfer section 122 transfers the web from the forming belt 120a to the oven belt 124a via the transfer belt 112a. The web is conveyed from the transfer section 122 to the oven 124, where it is heated sufficiently to cause the melting or softening of the polyethylene in the individuated bicomponent fibers and, optionally, in the scrim layer(s). Molten or softened polyethylene in contact with other fibers in the web creates bonds when the polyethylene is cooled and hardened. As the web exits the oven 124, it may be taken through an optional compression nip roller 125 in order to squeeze the web for the purpose of encouraging thermal bonds and possibly to intentionally reduce the bulk of the finished product. The web is then cooled in a cooling section 126 in order to set the thermal bonds.

FIG. 2 illustrates a number of possible alternatives for converting the web into desired forms and sizes. An edge slitter 127 may be used for trimming the edges of the web to a fixed width. After the edge slitter 127, converting alternatives may be provided by using a sheeter 128, festooner 129, winder 130, or other devices to cut, stack, fold, or wind the web.

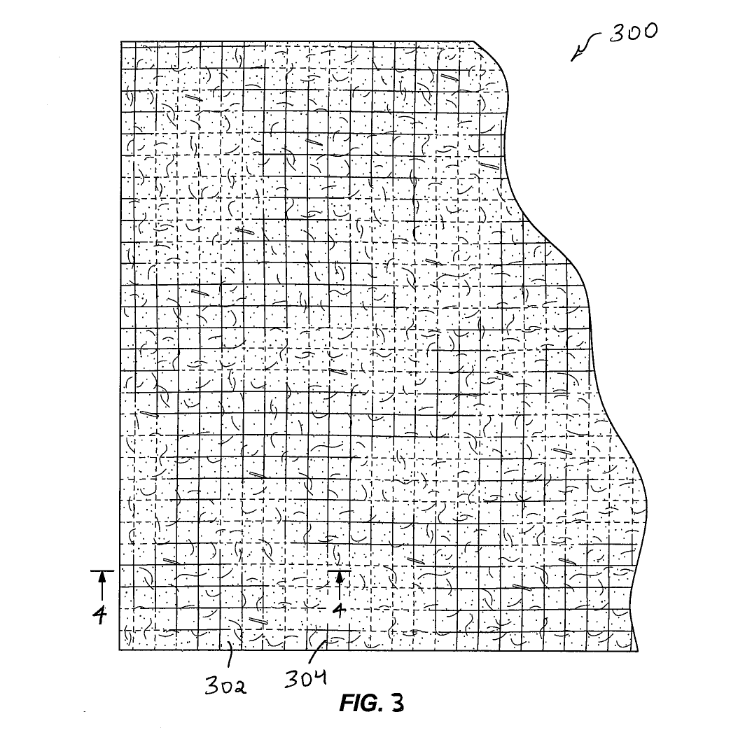

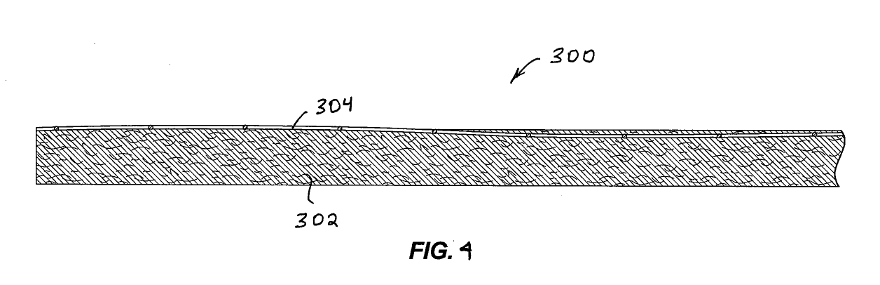

FIGS. 3 and 4 show a pad 300, such as an absorbent, filter, insulator, etc., that includes a web of cotton regin and bicomponent fibers 302 and netting 304. As mentioned above, netting may be incorporated in an end product (e.g., pad 300) by unrolling the netting 304 from the first unwinder 121 and holding the netting above the forming belt 120a for a distance (see FIG. 2), such that some of the cotton regin and bicomponent fiber 302 fall through the netting 304. The netting 304 is then lowered onto the forming belt 120a and onto any cotton regin and bicomponent fiber 302 that has fallen through the netting 304. Thus, as shown in FIGS. 3 and 4, the netting 304 is at least partially embedded in the web material.

For example, in the embodiment shown in FIG. 3, the pad 300 includes multiple areas 305 where the netting 304 is visible on a top surface 306 of the pad. The pad 300 also includes multiple areas 307 where the netting 304 is not visible on the top surface 306 (as is shown by phantom lines). In other constructions, the netting 304 can be embedded in the web material to a greater or lesser extent, depending upon, among other things, the size of netting 304 used and the average particle size of the cotton regin and bicomponent fiber 302.

The pad 300 is directed through the oven 124, as described above. The outer layer of the individuated bicomponent fibers 302 melts in the oven 124 and bonds with the cotton regin fibers. In the illustrated construction, the netting 304 does not have any adhesive properties, nor does the illustrated netting 304 melt in the oven 124. Rather, the netting 304 is secured to the pad 300 because the netting 304 is at least partially embedded in the web material. The cotton regin and bicomponent fiber 302 is positioned on opposite sides of the netting 304 when the pad 300 is sent through the oven 124 so that the web material forms bonds around the netting 304. The bicomponent fiber 302 can also bond directly to the netting 304. A nip roller 125 can be used to compress the pad 300, and further secure the netting 304 to the cotton regin and bicomponent fibers 302. The netting 304 increases the strength of the pad 300, without significantly decreasing the absorbency and/or insulation properties of the pad 300.

In another construction (not shown), the netting 304 may be fully embedded into the pad 300, such that the netting 304 is not visible through the cotton regin and bicomponent fiber 302. In yet another construction (not shown), netting 304 may be included on both a top and a bottom of the pad 300. Further, in another construction (not shown), the netting 304 may have adhesive properties and/or may soften or melt when the pad 300 is sent through the oven 124 to at least partially bond with the web material.

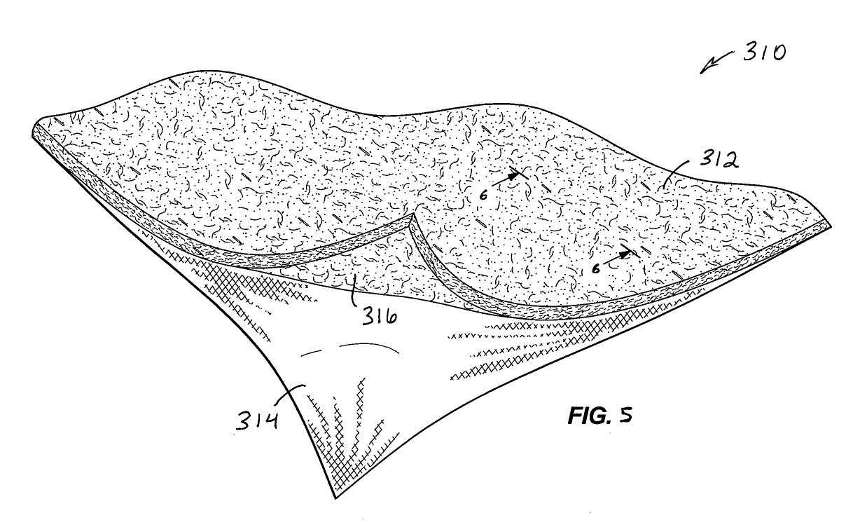

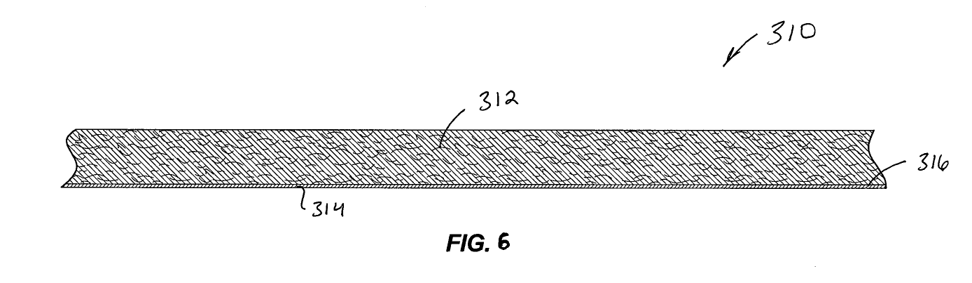

FIGS. 5 and 6 show a pad 310 that includes a web of cotton regin and bicomponent fibers 312 and a scrim 314. The scrim 314 is secured to a surface 316 of the pad 310. The scrim 314 can be positioned under the cotton regin and bicomponent fiber 312, such as in step 21, or can be positioned above the cotton regin and bicomponent fiber 312, such as in step 23. When only one scrim 314 is used, it may be desirable to position the scrim 314 below the cotton regin and bicomponent fiber 312, to ease movement along the forming belt 120a. As discussed above, in other constructions (not shown), the product can include a scrim layer on both surfaces of the web. Generally, the scrim 314 increases the strength and/or scuff resistance of the pad 310 without substantially decreasing the absorbent and insulating properties of the pad 310.

When the pad 310 travels through the oven 124, the outer layer of the bicomponent fibers 312 partially melts and also adheres to the scrim 314, to secure the scrim 314 to the pad 310. In another construction, the scrim 314 has a melting point chosen so that it partially melts in the oven 124 to adhere to fibers in the web.

If additional assurance of bonding is desired, the scrim 314 is pressed against the pad 310 by the nip roller 125 after being heated in the oven.

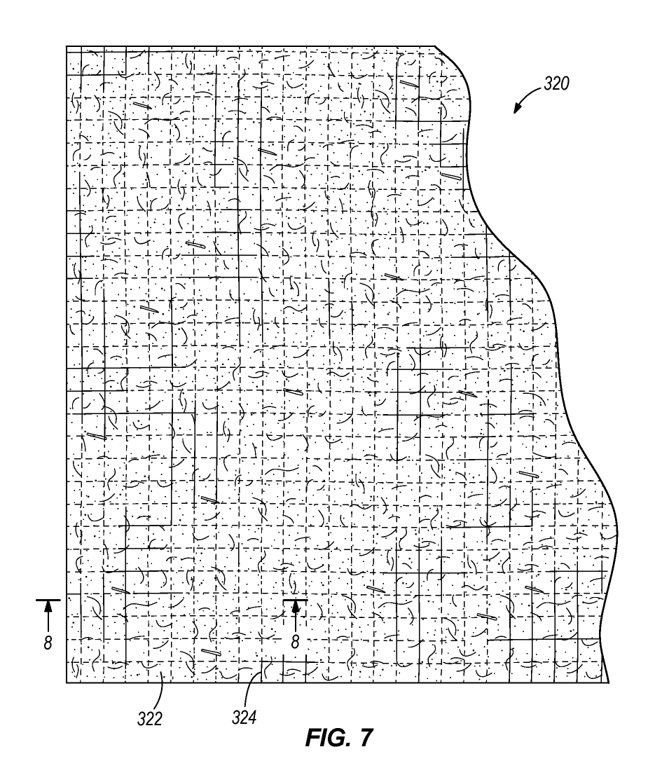

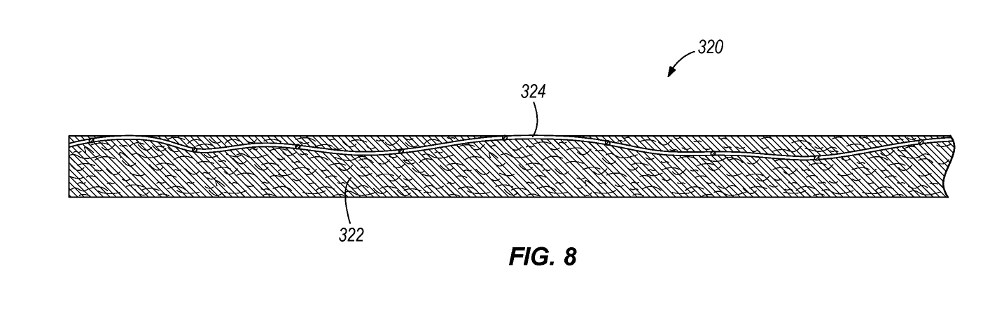

FIGS. 7 and 8 show an alternative pad 400, such as an absorbent, filter, insulator, etc., that includes a web of cotton regin and bicomponent fibers 402 and netting 404. As mentioned above, netting may be incorporated in an end product (e.g., pad 400) by unrolling the netting 404 from the first unwinder 121 and holding the netting above the forming belt 120a for a distance (see FIG. 2), such that some of the cotton regin and bicomponent fiber 402 fall through the netting 404. The netting 404 is then lowered onto the forming belt 120a and onto any cotton regin and bicomponent fiber 402 that has fallen through the netting 404. Thus, as shown in FIGS. 7 and 8, the netting 404 is at least partially embedded in the web material.

For example, in the embodiment shown in FIG. 7, the pad 400 includes relatively few areas where the netting 404 is visible on a top surface 406 of the pad. The pad 400 also includes many areas where the netting 404 is not visible on the top surface 406 (as is shown by phantom lines).

In other constructions, the netting 404 can be embedded in the web material to a greater or lesser extent, depending upon, among other things, the size of netting 404 used and the average particle size of the cotton regin and bicomponent fiber 402. In some embodiments, the netting 404 is embedded between 0% and 25% of the thickness of the pad 400. In some embodiments, the netting 404 is embedded between 0% and 50% of the thickness of the pad 400. In some embodiments, the netting 404 is substantially positioned in a middle of the pad 400.

In another construction (not shown), the netting 404 may be fully embedded into the pad 400, such that the netting 404 is not visible through the cotton regin and bicomponent fiber 402. In yet another construction (not shown), netting 404 may be included on both a top and a bottom of the pad 400. Further, in another construction (not shown), the netting 404 may have adhesive properties and/or may soften or melt when the pad 400 is sent through the oven 124 to at least partially bond with the web material.

The pad 400 is directed through the oven 124, as described above. The outer layer of the individuated bicomponent fibers 402 melts in the oven 124 and bonds with the cotton regin fibers. In the illustrated construction, the netting 404 does not have any adhesive properties, nor does the illustrated netting 404 melt in the oven 124. Rather, the netting 404 is secured to the pad 400 because the netting 404 is at least partially embedded in the web material. The cotton regin and bicomponent fiber 402 is positioned on opposite sides of the netting 404 when the pad 400 is sent through the oven 124 so that the web material forms bonds around the netting 404. The bicomponent fiber 402 can also bond directly to the netting 404. A nip roller 125 can be used to compress the pad 400, and further secure the netting 404 to the cotton regin and bicomponent fibers 402. The netting 404 increases the strength of the pad 400, without significantly decreasing the absorbency and/or insulation properties of the pad 400.

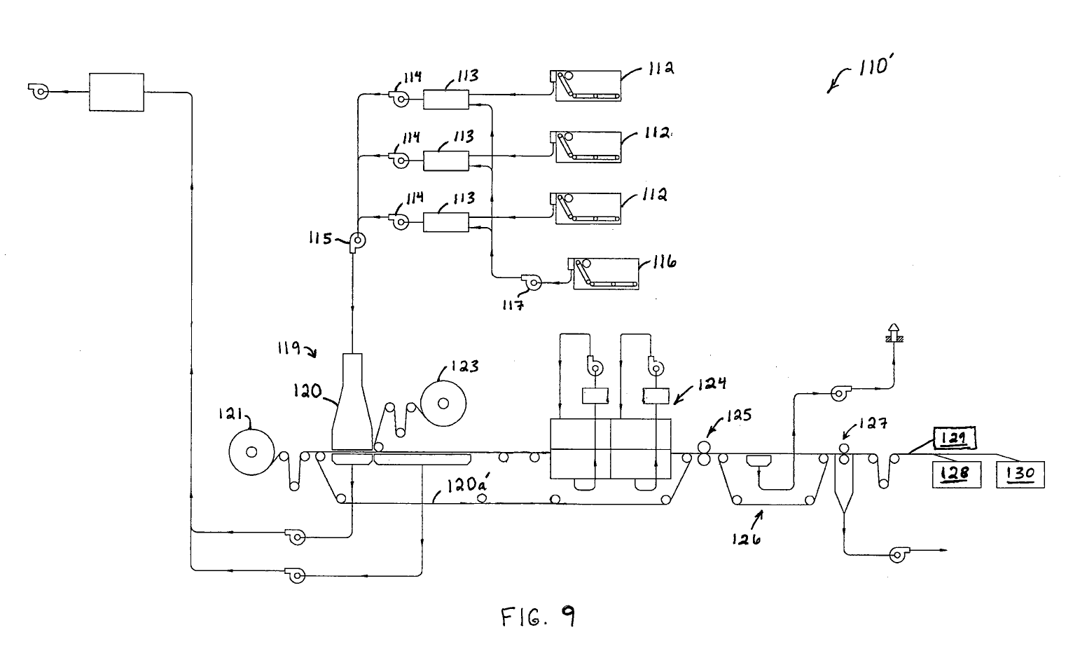

FIG. 9 is schematic view of an alternate manufacturing line 110′ that can be utilized to manufacture any of the absorbents, insulators or filters in accordance with the present invention. The manufacturing line 110′ is similar to the manufacturing line 110, so only the different components will be indicated with a prime (′) and discussed in detail. The manufacturing line 110′ omits the transfer section 122 and includes a single forming/oven belt 120a′ that extends through the reserve section 119 and the oven 124. In the illustrated embodiment, the web is formed on the belt 120a′ and transferred directly into the oven 124 without the need of a transfer section. All of the features and components from FIG. 2 not specifically discussed with respect to FIG. 9 can be utilized with the embodiment of FIG. 9.

U.S. patent application Ser. Nos. 11/538,746, filed Oct. 4, 2006; 11/789,187, filed Apr. 23, 2007; and 12/317,610, filed Dec. 26, 2008, disclose similar products, such as absorbents, filters, insulators, etc., including a web and, optionally, scrim or netting layer(s) and similar methods of manufacturing such products. The entire contents of each of these patent applications is hereby incorporated by reference.

As should be apparent from the above, independent embodiments of the invention provide webs for use, for example, as industrial hydrophobic absorbents, and methods of manufacturing the same. Various features, advantages, and embodiments of the invention are set forth in the following claims:

What is claimed is:

1. An industrial absorbent comprising:
an air-laid web including
cotton regin; and
individuated bicomponent fibers mixed with the cotton regin, the cotton regin being shortened prior to mixing with the individuated bicomponent fibers, at least some of the bicomponent fibers in the web being thermally bonded to at least some of the shortened cotton regin.

2. The absorbent of claim 1, wherein the amount of bicomponent fiber included in the web is between 6% and 12% of a total weight of the air-laid web.

3. The absorbent of claim 1, wherein the air-laid web has a bulk-to-weight ratio of about 25 to about 40 mils/osy.

4. The absorbent of claim 1, further comprising an air-permeable layer of thermoplastic scrim thermally bonded to an outer surface of the air-laid web.

5. The absorbent of claim 1, further comprising a layer of netting at least partially embedded within the air-laid web.

6. The absorbent of claim 1, wherein the air-laid web has an absorbency of about 20 to about 30 times a dry weight of the web.

7. A method of manufacturing an air-laid industrial absorbent, the method comprising:
providing cotton fibers produced as a byproduct of a cotton ginning process;
reducing a length of the cotton fibers;
mixing the reduced-length cotton fibers with bicomponent fibers, the bicomponent fibers including a first material having a first melting point and a second material having a second melting point, the second melting point being lower than the first melting point;
forming a web with the mixed fibers;
heating the web in an oven to cause the second material to soften; and
cooling the heated web to create bonds between at least some of the bicomponent fibers and at least some of the cotton fibers.

8. The method of claim 7, further comprising conveying the combined fibers into one of chute and a reserve section above a forming head.

9. The method of claim 8, further comprising:
metering the mixed fibers into the forming head; and
depositing the mixed fibers with the forming head onto a moving forming belt.

10. The method of claim 9, further comprising controlling a flow of cotton fibers and a flow of the bicomponent fibers.

11. The method of claim 9, further comprising, prior to heating the mixed fibers, positioning a thermoplastic scrim adjacent the forming belt such that mixed fibers are deposited onto the scrim, the scrim being on a bottom surface of the web.

12. The method of claim 11, further comprising, prior to heating the mixed fibers, positioning a second thermoplastic scrim on a top surface of the mixed fibers.

13. The method of claim 7, further comprising:
positioning a netting at a height above a forming belt;
permitting at least some of the mixed fibers to fall through the netting during web formation; and
prior to heating the combined fibers, lowering the netting onto the at least some of the mixed fibers on the forming belt such that the netting is at least partially embedded in the mixed fibers.

14. The method of claim 7, further comprising removing debris from the cotton fibers before mixing with the bicomponent fibers.

15. A product for use as at least one of an absorbent, a filter and an insulator, the product comprising:
an air-laid web including
cotton regin; and
individuated bicomponent fibers mixed with the cotton regin, the cotton regin being shortened prior to mixing with the individuated bicomponent fibers, at least some of the bicomponent fibers in the web being thermally bonded to at least some of the shortened cotton regin.

16. The product of claim 15, wherein the amount of bicomponent fiber included in the web is between 6% and 12% of a total weight of the air-laid web.

17. The product of claim 15, wherein the web has a bulk-to-weight ratio of about 25 to about 40 mils/osy.

18. The product of claim 15, further comprising an air-permeable layer of thermoplastic scrim thermally bonded to an outer surface of the air-laid web.

19. The product of claim 15, further comprising a first air-permeable layer of thermoplastic scrim thermally bonded to a first surface of the air-laid web and a second air-permeable layer of thermoplastic scrim thermally bonded to a second surface of the air-laid web.

20. The product of claim 15, further comprising a layer of netting at least partially embedded within the air-laid web.

21. The product of claim 15, wherein the web has an absorbency of about 20 to about 30 times a dry weight of the air-laid web.
